(19) United States
(12) Patent Application Publication
(10) Pub. No.: US 2016/0052058 A1
(43) Pub. Date: Feb. 25, 2016

(54) METHOD FOR PRODUCING A THREE-DIMENSIONAL COMPONENT

(71) Applicant: FIT AG, Lupburg (DE)

(72) Inventors: Alexander BONKE, PARSBERG (DE); Alexander OSTER, REGENSBURG (DE)

(21) Appl. No.: 14/780,627

(22) PCT Filed: Mar. 25, 2014
(86) PCT No.: PCT/EP2014/000804

§ 371 Date: Sep. 28, 2015

(30) Foreign Application Priority Data
Mar. 28, 2013 (DE) 10 2013 103 249.4

(51) Int. Cl. B22F 3/105; B28B 1/00; B29C 67/00

(52) U.S. Cl. CPC B22F 3/1055; B29C 67/0077; B28B 1/001; B33Y 10/00

(57) ABSTRACT

The invention relates to a method for manufacturing a three-dimensional component. It is proposed to manufacture, during the build operation in the build space of the layer manufacturing system, not only the component but also at least one characterizing element associated with the component. The characterizing element allows simple, fast, and reliable sorting of the three-dimensional components.

The invention relates to a method for manufacturing a three-dimensional component by application of a build material in layers. The invention furthermore relates to a method for identifying a component manufactured using such a method, and to a method for further processing of a component identified with such a method. Lastly, the invention also relates to a layer manufacturing system embodied to carry out these methods.

Layer manufacturing methods, which are also referred to as “additive manufacturing” methods, serve to manufacture components built up in layers from a solidifiable material such as resin, plastic, metal, or ceramic, and are used, for example, to produce engineering prototypes. A variety of additive manufacturing methods based on the layer building method, and systems for carrying them out, are known from the existing art, for example stereolithography, selective laser melting, selective mask sintering, fused deposition molding, Polyjet, 3D printing, etc.

The build operation occurs in a process chamber (often closed) that is also referred to as a “build chamber” or “build space.” Systems with which a layer manufacturing method of this kind is carried out are also referred to as “rapid prototyping” systems.

Whereas in the past, prototypes and individual items, as well as short production runs, were what was principally produced using layer manufacturing methods, there is nowadays an increasing transition to additive manufacturing on an industrial scale. It is often not identical components, but components similar to one another, that are produced in this mass-production context. These can be components individualized to customer specifications, for example replacement cases for a mobile telephone, or can be parts that are similar to one another for other reasons.

In order to utilize the available build space as efficiently as possible, multiple components are manufactured simultaneously in a shared build space of a production system during one build operation. These can also be components for different customers.

Subsequently thereto, the manufactured parts must be sorted, for example so the components can be correctly labeled and packaged in a subsequent step. The identification of the components that is necessary for this is generally performed manually on the basis of external design features, for example the shape and/or color of the components, often based on build plans. This type of sorting is very laborious, slow, and error-prone.

An object of the present invention is to make possible simple, fast, and reliable sorting of three-dimensional components produced using a layer manufacturing method.

This object is achieved respectively by a method according to claim 1, a method according to claim 8, a method according to claim 9, a layer manufacturing system according to claim 11, and a computer program according to claim 12. Advantageous embodiments of the invention are described in the dependent claims. The advantages and embodiments explained below in conjunction with the methods also apply analogously to the layer manufacturing system according to the present invention and to the computer program, and vice versa.

A central idea of the invention is to manufacture, during the build operation in the build space of the layer manufacturing system, not only the component but also at least one characterizing element associated with the component. The characterizing element holds information about the component. The information held is preferably information that enables direct or indirect identification of the corresponding component. The advantageously unambiguous association of the characterizing element with the component makes possible simple, fast, and reliable identification subsequently to the manufacture of multiple components, and thus also a correspondingly advantageous sorting of the individual components.

This is even more applicable to batch production, in which not only a single component but instead multiple components, in particular multiple components similar to one another, are manufactured during one build operation, together with the corresponding characterizing elements, in a shared build space. The number of components arranged in the build space can vary greatly depending on the size of the components to be manufactured and the available build space.

In a simple case, each component has exactly one characterizing element associated with it. Multiple characterizing elements can, however, also be associated with one component. This is advantageous in particular when the component is made up of multiple subcomponents that are later separated from one another, for example for packaging purposes. It is then possible to ensure that each individual handleable subcomponent has a characterizing element associated with it.

A particularly advantageous embodiment of the invention is one in which the at least one characterizing element is manufactured in such a way that it lies substantially in the build plane. In other words, the characterizing element preferably extends exclusively or almost exclusively in the layer building plane of the build space. A characterizing element manufactured in this manner is substantially planar. It is preferably only one build layer or two build layers thick. The characterizing element is also preferably small. An area of approximately one square centimeter is usually sufficient to accommodate the necessary information on the characterizing element.

Thanks to these properties, the characterizing element requires very little space and can be arranged in build-space-optimized fashion, i.e. with optimal utilization of the build space. In addition, it entails only a low material cost and a very small additional data volume. A characterizing element of this kind can furthermore be manufactured particularly quickly. Because of the very small space requirement and very short build time, the increase in overall manufacturing cost is minimal or nonexistent.

An embodiment of the invention that has proven to be very particularly advantageous is one in which the at least one characterizing element is manufactured in such a way that it is equipped with a number of openings, the information being coded with the aid of the openings. In other words, the information is stored in the characterizing element using a special code. The code can be based, for example, on the size, shape, and/or arrangement of the openings.

It is particularly advantageous if coding of the component information, i.e. in particular coding of the information enabling identification of the component, is accomplished using a hole pattern applied in the characterizing element. Using an opening pattern or hole pattern of this kind it is possible to encode, on a characterizing element that possesses a usable area of, for example, one square centimeter, information that serves for unambiguous identification of a million components, i.e. for example a serial number in a series from zero to one million, without thereby impairing reliable readability of the opening pattern or hole pattern. In contrast to the application of letters or numbers in, on, or onto the characterizing element, in a particularly preferred embodiment of the invention the use of an opening pattern or hole pattern makes possible binary coding and thus (when suitable code conversion is utilized) accommodation of a much larger amount of information per unit of available area on the characterizing element. Reading out a binary code results, for example, in an opening or a hole being regarded as a binary “1”, and the absence of an opening or hole is regarded as a binary “0”. The opening pattern or hole pattern then corresponds, for example, to a bit pattern. The use of an opening pattern or hole pattern of this kind makes available a simple code that is machine-readable in fault-proof fashion. For this, the opening pattern or hole pattern is preferably introduced into the characterizing element in a defined and structured manner, in particular in the form of a matrix having a number of columns and/or a number of rows.

The information can also be encoded on the basis of the shape of the openings or holes. This type of coding can be the only coding; preferably, however, this type of coding is used in combination with one of the other coding options described. In this case different opening shapes or hole shapes are used, for example circular openings or holes in the shape of dots, or elongated openings or holes in the shape of lines.

The information can also be encoded on the basis of the size of the openings. This type of coding can be the only coding; preferably, however, this type of coding is used in combination with one of the other coding options described. In this case different opening sizes or hole sizes are used, i.e. for example circular openings or holes having different diameters.

This form of coding with the aid of an opening pattern or hole pattern not only makes it possible to accommodate in a very small space a data volume of sufficient size for identification of the characterizing element. It also ensures very reliable, preferably automatic reading of the code, and thus reliable recognition of the information. Reading is preferably accomplished optically, i.e. with the aid of an optical reading device. It is particularly advantageous in this connection to use a camera having an autofocus function as an optical reading device. Mechanical or electrical reading is, however, also possible in principle.

It is particularly advantageous if the openings are apertures, i.e. openings penetrating completely through the characterizing element. In this case the contrast necessary for optical reading can be guaranteed always and in all circumstances, optionally with the assistance of a light table or a contrast film. A transmitted-light method is preferably used for this. The binary code that is presented then results, at the receiver end, in the two states “light” and “no light.”

If what is used instead of the apertures are openings in the surface of the characterizing element which do not penetrate completely through the characterizing element, a contrast sufficient for reliable recognition can likewise be provided by suitable illumination, for example incident at a specific angle, for example by way of a shadow cast as a result of such an illumination. An incident-light method is preferably used for this.

If coding of the information is accomplished solely by way of the arrangement of the openings in the characterizing element, the shape selected for the openings can then be selected without restriction. The shape of the openings is, however, advantageously selected so that the necessary readability or detectability exists.

The above-described coding of the information with the aid of openings or apertures ensures reliable optical recognition of the information even when a single-color build material is used to manufacture the component and the characterizing element. With a single-color build material, reliable optical recognition of coded information, for example in the form of a barcode applied only onto the surface of the characterizing element, is otherwise not possible with usual reading devices due to the absence of contrast.

The use of openings or apertures in combination with suitable sensing means, in particular optical cameras having an autofocus function, and optionally with suitable data processing means, furthermore enables reliable reading and processing of the information even when the characterizing element is bent, for example due to inadvertent incorrect handling after the build operation is complete.

In a further advantageous embodiment of the invention, the information held by the characterizing element is automatically generated in a step preceding the build operation, and/or the characterizing element is, preferably automatically, associated with the component in a step preceding the build operation. In other words, even before the components are manufactured, the information is generated in uncoded or coded form and is associated with a specific component or subcomponent. With a small number of components to be manufactured simultaneously, this can be done by hand. Preferably the information is generated, and the association created, entirely automatically, for example with the aid of a software program for producing the build plan which has the corresponding functionality.

It is advantageous in the context of the present invention if the characterizing element is physically associated with the component. In other words, the characterizing element is preferably connected in mechanical fashion to the component. A variety of mechanical connections can be utilized here.

In an advantageous embodiment of the invention, the characterizing element is manufactured in such a way that it is nondetachably connected to the component. In this case the characterizing element is preferably applied on or onto the component, i.e. configured as an integral constituent of the component.

The characterizing element can then be used, for example, as a certificate of authenticity, in particular when the information encompasses a coded serial number. In this case the customer can use the characterizing element to check the authenticity of his or her product, or in order to verify authenticity. It is possible, for example, for the customer to photograph the characterizing element and send the photo to the manufacturer in order to check or verify authenticity; this can be followed by further business activities, for example additional manufacturer services. A suitable software application can, however, also enable the customer to check the authenticity of the product him- or herself.

In another advantageous embodiment of the invention the characterizing element is manufactured in such a way that it is connected to the component with the aid of a connecting element inherent in the component. In a simple embodiment, this is achieved with the aid of a connecting element connecting the characterizing element to the component directly and without intermediation, such as a material strip or the like that is to be severed later. In this case a connection that is nondetachable in the conventional sense is embodied in such a way that it can be destroyed and thus detached. A different connection that is detachable in the conventional sense can, however, also be provided. For example, the component and the characterizing element can comprise connecting elements for constituting a latching connection or snap connection.

In a further advantageous embodiment of the invention, the characterizing element is manufactured in such a way that it is connected to the component via a coupling element external to the component. The coupling element is preferably embodied as a physically separate element. In other words, the coupling element is neither part of the component nor part of the characterizing element. A coupling element that is embodied in the manner of a loop, and is passed through a first aperture provided in the component and through a second aperture provided in the characterizing element, has proven particularly advantageous. As compared with a characterizing element that is connected to the component directly and without intermediation via a connecting element, the use of a coupling element is associated with the advantage that the component is not damaged by the removal of the connecting element embodied as a strip or the like. With the use of a coupling element that can be severed or destroyed in order to release the characterizing element, there is no risk that the association of the characterizing element with the component will leave undesired traces on the component.

In order to make the best possible use of the available build space and to achieve high loading efficiency, a corresponding optimization is usually performed when arranging the components to be manufactured. In a further advantageous embodiment of the invention, not only the position of the component but also the position of the respective characterizing element in the build space are automatically determined in a step preceding the build operation. The optimum position of the characterizing element which best utilizes the build space is preferably ascertained fully automatically with the aid of a software program for preparing the build plan which exhibits the corresponding functionality. Suitable locations at which the characterizing element could be placed can already be identified and/or selected, manually, semiautomatically, or fully automatically, at an early point in time at which the number and shape of the components to be manufactured are not yet finally defined. Preferably, fully automatic identification and selection of the suitable position are accomplished as soon as the components being produced, and the open spaces that are available, are defined.

Assisting this working space optimization is the fact that the characterizing element according to the present invention is preferably substantially planar, i.e. encompasses, for example, only one or two build layers; and that very flexible positioning of the characterizing element relative to the pertinent component is therefore possible. It is therefore easy to arrange the characterizing element in narrow gaps, interstices, or openings, so that very good build space utilization is achievable. In the simplest case, the characterizing element can be arranged at a very short distance above the respective component without thereby substantially increasing the overall height.

Further processing options that can be implemented based on the fundamental idea of the present invention are obtained in conjunction with the above-described manufacture of the three-dimensional component.

The present invention therefore proposes a method for identifying a component manufactured in that manner, which method is characterized in that preferably automatic optical recognition of that information which is held by the at least one characterizing element associated with the component is accomplished; and that preferably automatic identification of the component is accomplished on the basis of that information. For that purpose, a characterizing element separate from the component associated with it, or the component having the characterizing element connected thereto, is delivered to an optical reading unit, or the optical reading unit is moved to the characterizing element. Subsequently to the actual reading operation or recognition operation, identification of the component associated with the characterizing element is accomplished with the aid of a data processing unit, which in the simplest case queries a correspondingly provided database. Errors in reading out the information and in associating the information with a component can thereby be largely avoided. Identification costs in the sector of additive manufacturing, in particular in a context of similar components, can therefore be appreciably lowered by utilizing the invention.

Also proposed is a method for further processing of a component identified in this manner, said method being characterized in that the further processing is accomplished as a function of the result of the identification and/or utilizing the result of the identification. For example, a packaging process subsequent to identification is accomplished as a further processing step as a function of the identification result.

It is particularly advantageous in this connection if the component is a test article, and if the further processing encompasses a check of the manufacturing quality of the component. In this case the result of the identification is used in order to arrive at a knowledge of the position of the test article in the build space. A quality check is accomplished as a subsequent processing step using the result of the identification, namely using the knowledge of the position of the test article.

Within the context just described, a partial aspect of the present invention can also be regarded as a method for manufacturing a particularly easily, preferably automatically, identifiable test article, which is notable for the fact that the position of the test article during the build operation can be ascertained, preferably automatically, by subsequently reading out the information of the characterizing element. Following manufacture, it is therefore possible to automatically associate the location of the test article, i.e. of the build site to be tested, with the test result, i.e., for example, with the performance of the laser used to melt the build material. The high speed at which the test article can be identified, and at which the location of the test article in the build space can be ascertained, is particularly advantageous here. As a result, testing time is substantially reduced as compared with all procedures hitherto known, and the entire build space can be checked at high resolution essentially with no time delay, i.e. using a plurality of test articles arranged in distributed fashion over the entire build space.

The test article can be one of the components that were to be manufactured in any case in accordance with the build plan. In this case the component is further processed in the usual manner once testing is complete. The test article can, however, also be a dedicated test article that is produced, in addition to the other components, exclusively for test purposes. In this case the test article can exhibit, in terms of shape and size, the same physical features as the characterizing element associated with the test article, so that there is no, or no substantial, increase in the build time for manufacturing the test article, and the test article can be arranged in the build space in space-optimized fashion. In the simplest case an individual characterizing element, i.e. one produced without reference to another component, can itself be used as a test article, since it carries with it the information needed for a knowledge of its position in the build space.

The layer manufacturing system according to the present invention is embodied to carry out some or all method steps for manufacturing the three-dimensional component and/or for identification and/or for further processing.

The computer program according to the present invention comprises computer program instructions for carrying out some or all method steps for manufacturing the three-dimensional component and/or for identification and/or for further processing, or for controlling a layer manufacturing system according to the present invention, when the computer program is executed on a computer. The computer program according to the present invention encompasses, in particular, computer program instructions for automatically generating the information held by the characterizing element in a step preceding the build operation, and/or computer program instructions for automatically associating the characterizing element with the component in a step preceding the build operation, and/or computer program instructions for automatically ascertaining the position of the characterizing element in the build space relative to the component in a step preceding the build operation, and/or computer program instructions for controlling a layer manufacturing system in order to carry out the aforesaid method steps, when the computer program is executed on a computer.

The apparatus according to the present invention encompasses for this purpose a data processing unit embodied to carry out all the steps in accordance with the methods described here which have a correlation with the processing of data. The data processing unit preferably comprises a number of functional modules, each functional module being embodied to carry out a specific function or a number of specific functions in accordance with the methods described. The functional modules can be hardware modules or software modules. In other words, the invention can be realized, to the extent that it relates to the data processing unit, either in the form of computer hardware or in the form of computer software or in a combination of hardware and software. If the invention is realized in the form of software, i.e. as a computer program product, all the functions described are realized by way of computer program instructions when the computer program is executed on a computer having a processor. The computer program instructions are realized in a known manner in any programming language and can be furnished to the computer in any form, for example in the form of data packets that are transferred via a computer network, or in the form of a computer program product stored on a diskette, a CD-ROM, or another data medium.

Exemplifying embodiments of the invention will be explained in further detail below with reference to the drawings, in which:

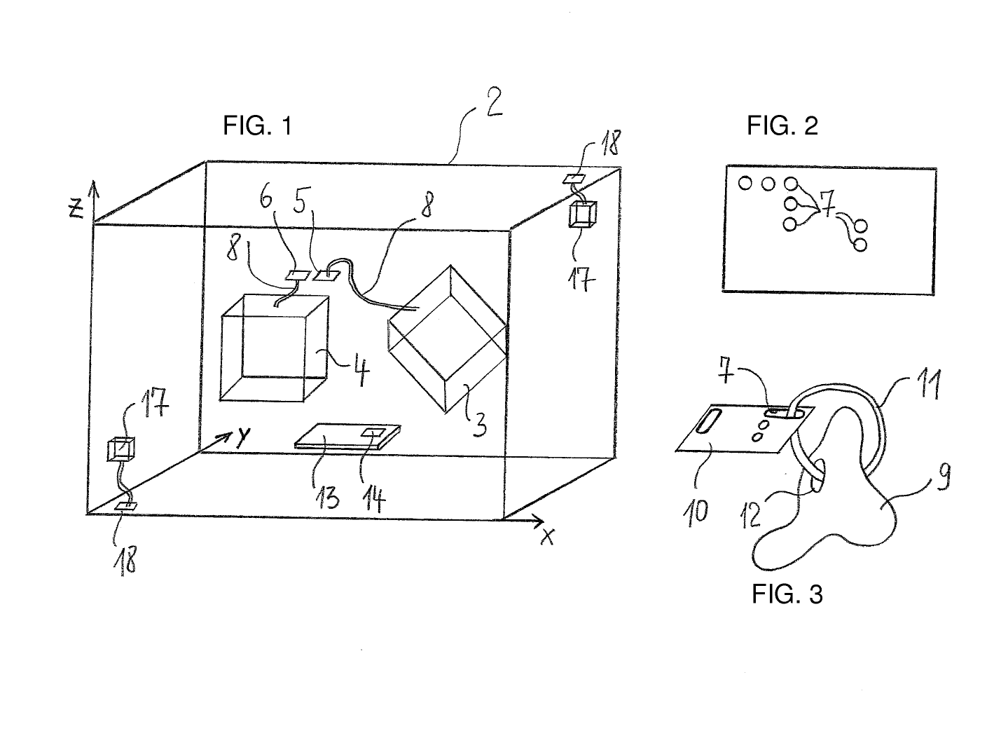

FIG. 1 schematically depicts a build space of a layer manufacturing system having multiple components to be manufactured simultaneously;

FIG. 2 is a plan view of a characterizing element according to the present invention;

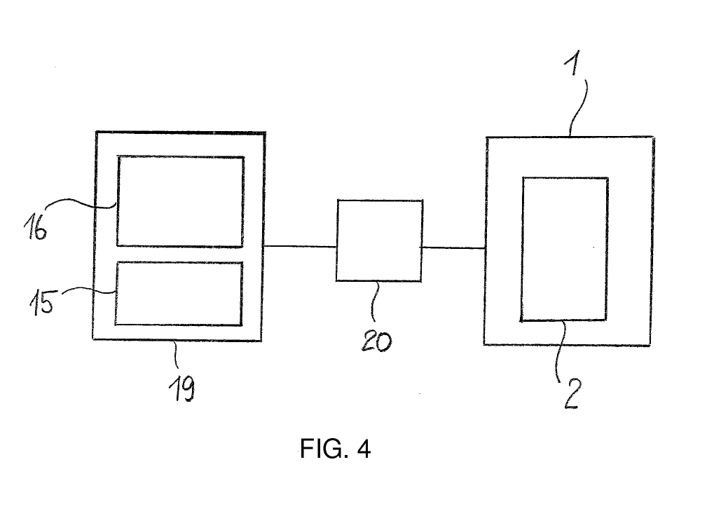

FIG. 3 shows a component having a characterizing element;

FIG. 4 is a block depiction of the manufacturing system with a reading and identification unit.

All the Figures show the invention not true to scale, merely schematically, and only with its essential constituents. Identical reference characters correspond to elements having an identical or comparable function.

A method with which three-dimensional components can be manufactured directly from the corresponding design data with the aid of an additive manufacturing method will be described by way of example. The components are built up in layers by applying successive layers of a build material one above another in a Z direction. Before the respective subsequent layers are applied, those points in the respective layers which correspond to the component to be produced are selectively solidified. Solidification is accomplished by local heating of the powdered build material with the aid of a radiation source. An exactly defined component structure of any kind can be generated by introducing radiation in suitably controlled fashion into the desired regions. The three-dimensional component is manufactured by successively generating multiple thin, individually configured layers. One skilled in the art is fundamentally familiar with this method, and also has knowledge of other layer building methods in which the invention can be utilized.

During the build operation, not only a number of components 3, 4 similar to one another, but also characterizing elements 5, 6 associated with components 3, 4, are manufactured in a shared build space 2 of a layer manufacturing system 1 (see FIG. 1). Characterizing elements 5, 6 hold information about the respective component 3, 4 which enables identification of the individual components 3, 4. In the present case this refers to the serial numbers of components 3, 4.

Characterizing elements 5, 6 are only one or two build layers thick, are therefore substantially planar, and are located substantially in the build plane (X-Y plane), so that the build time is very short. No letters or numbers are applied on the characterizing element for identification. Instead, each characterizing element 5, 6 is provided with a number of apertures 7 that result in a hole pattern with which the information is coded (see FIG. 2). Preferably a binary code is implemented. Apertures 7 can be simple circular holes having identical diameters. The component information for identifying components 3, 4 is thus coded in characterizing elements 5, 6 by way of the manner in which apertures 7 are arranged.

In the case of components 3, 4 illustrated in FIG. 1, which here are cube-shaped in the interest of simplicity, characterizing elements 5, 6 are connected to the respective components 3, 4 with the aid of a connecting element inherent in the component, in the form of a material strip 8 that can be severed later.

In the case of component 9 depicted individually in FIG. 3, characterizing element 10 is manufactured in such a way that it is connected to component 9 via a coupling element 11 external to the component. Coupling element 11, in the form of a loop, is passed through an aperture 12 in component 9 and an aperture 7 in characterizing element 10, and can be severed after manufacture with no damage to component 9.

In the case of a further component 13 illustrated in FIG. 1 (here, for example, a flat mobile telephone case), characterizing element 14 is integrated into component 13.

After manufacture, characterizing elements 5, 6, 10, 14 are successively read either individually, i.e. separately from the respective components 3, 4, 9, or together with components 13, with the aid of an optical reading device in the form of a (video) camera 15 having an autofocus function. For this purpose, characterizing elements 5, 6, 10, 14 are placed relative to a suitable illumination arrangement, here on a light table 16. The light sources arranged in light table 16 shine through the hole pattern so that the contrast necessary for proper sensing of the hole pattern, as a rule a light/dark contrast, exists in all circumstances. The hole pattern is sensed by camera 15, and the image information is stored and/or forwarded in suitable fashion.

Once the hole pattern has been read, components 3, 4, 8, 13 are identified by suitable data processing means, on the basis of the information read out, by converting the code. Instead of image recognition, which would be necessary, for example, if letters or numbers were used to identify the components, all that is needed is to sense the hole pattern, i.e. to sense a defined arrangement of “light”/“no light” structures.

Simultaneously with components 3, 4, 13 and characterizing elements 5, 6, 14, a number of test articles 17, which are likewise connected to characterizing elements 18, are manufactured in the shared build space 2. The information from these characterizing elements 18 is likewise read out, and test articles 17 are identified. The location of test articles 17 is then automatically associated with the test result with the aid of suitable data processing means.

A data processing unit 20 that is embodied to carry out the corresponding method steps is connected to reading and identification unit 19 and to layer manufacturing system 20 (see FIG. 4).

All the features presented in the description, in the claims that follow, and in the drawings can be essential to the invention both individually and in any combination with one another.

### LIST OF REFERENCE CHARACTERS

1 Layer manufacturing system
2 Build space
3 Similar component
4 Similar component
5 Characterizing element
6 Characterizing element
7 Aperture
8 Material strip
9 Component
10 Characterizing element
11 Coupling element
12 Aperture
13 Component
14 Characterizing element
15 Camera
16 Light table
17 Test article
18 Characterizing element
19 Reading and identification unit
20 Data processing unit

1-12. (canceled)

13. A method for manufacturing a three-dimensional component, which comprises the steps of:
applying a build material in layers for forming the three-dimensional component during a build operation; and
during the build operation, manufacturing both the three-dimensional component and at least one characterizing element associated with the three-dimensional component in a shared build space of a layer manufacturing system, the characterizing element containing information about the three-dimensional component.

14. The method according to claim 13, which further comprises manufacturing multiple components as well as multiple characterizing elements associated with the multiple components during the build operation.

15. The method according to claim 13, which further comprises manufacturing the at least one characterizing element in such a way that the characterizing element lies substantially in a build plane.

16. The method according to claim 13, which further comprises manufacturing the at least one characterizing element such that the characterizing element is formed with a number of openings for coding the information.

17. The method according to claim 13, wherein:
the information held by the characterizing element is automatically generated in a step preceding the build operation; and/or
the characterizing element is automatically associated with the component in a step preceding the build operation.

18. The method according to claim 13, which further comprises manufacturing the characterizing element such that the characterizing element is:
non-detachably connected to the component; or
connected to the component with an aid of a connecting element inherent in the component; or
connected to the component via a coupling element external to the component.

19. The method according to claim 13, which further comprises determining a position of the characterizing element in the shared build space relative to the component in a step preceding the build operation.

20. The method according to claim 18, which further comprises connecting the characterizing element such that the characterizing element is applied on or onto the component.

21. A method for identifying a component manufactured by applying a build material in layers for forming the component and during a build operation, both the component and at least one characterizing element associated with the component are manufactured in a shared build space of a layer manufacturing system, the characterizing element containing information about the three-dimensional component, which comprises the steps of:
performing an automatic optical recognition procedure to identify the information held by the at least one characterizing element associated with the component; and
automatically identifying the component on a basis of the information.

22. A method for further processing of a component identified with the method according to claim 21, wherein the further processing is accomplished as a function of a result of an identification and/or utilizing a result of the identification.

23. The method according to claim 22, wherein the component is a test article, and the further processing encompasses a check of a manufacturing quality of the component.

24. A layer manufacturing system embodied to carry a method according to claim 13.

25. A non-transitory medium carrying a computer program to be executed on a computer for carrying out a method according to claim 13.
